(19) United States
(12) Patent Application Publication
(10) Pub. No.: US 2013/0064509 A1
(43) Pub. Date: Mar. 14, 2013

(54) OPTICAL FIBER CONNECTOR

(71) Applicants: MARK W. BYER, Mountain View, CA (US); Manuel J. Leonardo, San Francisco, CA (US); David Tracy, Bend, OR (US)

(72) Inventors: MARK W. BYER, Mountain View, CA (US); Manuel J. Leonardo, San Francisco, CA (US); David Tracy, Bend, OR (US)

(73) Assignee: Mobius Photonics, Inc., Mountain View, CA (US)

(21) Appl. No.: 13/229,383

(22) Filed: Sep. 9, 2011

(51) Int. Cl. G02B 6/38; G02B 6/36

(52) U.S. Cl. 385/72; 385/78; 385/79

(57) ABSTRACT

An optical fiber connector apparatus may include a ferrule having a hollow through its center. The hollow is sized and shaped to receive an optical fiber such that an end of each of the optical fiber is located at an endface of the ferrule. The endface of the ferrule is partitioned into a first section and a second section. The first section is perpendicular to an axis of the ferrule and the second section is angled with respect to the first section. When the connector is assembled, the ferrule can butt couple to a similarly configured second ferrule such that the perpendicular second portions of the endfaces of the ferrules are physically touching. The angle of the angled portions sets a distance between portions of the endfaces corresponding to endfaces of optical fibers received in the ferrules thereby setting a gap between the fiber endfaces.

### FIELD OF THE INVENTION

Embodiments of the present invention relate to optical fibers and more specifically to an apparatus for optically coupling a first group of one or more optical fibers to a second group of one or more optical fibers

### BACKGROUND OF THE INVENTION

In an optical fiber network, optical fiber connectors are used to couple light from an optical cable that includes a group of one or more optical fibers to another optical cable having another group of optical fibers. Most fiber optic connectors include the same three basic components: a ferrule, a ferrule body, and a connector body.

The ferrule receives an end of the optical cable and its associated optical fibers and provides a fiber alignment mechanism for aligning the optical fiber(s) in one optical cable with optical fiber(s) in another optical cable, such that light is efficiently coupled between the fibers in the two cables. The ferrule typically surrounds the optical cable in a manner such that the ends of the optical fibers are located at the end of the ferrule. In order to couple light, each ferrule is aligned with a corresponding ferrule in a mating component of the connector such that their respective groups of optical fibers are optically coupled.

A ferrule body holds the ferrule. The ferrule typically extends beyond the ferrule body, to facilitate optical coupling. The ferrule body may provide a second alignment mechanism for the fiber optic connector. By way of example, and not by way of limitation, ferrule bodies may include keys that are configured to lock the fiber optic connector in place during optical coupling to prevent the occurrence of rotation.

The optical cable surrounds the group of optical fibers and is attached to the ferrule body. It provides a point of entry for the group of optical fibers, and is configured such that the ends of the optical fiber or fibers that make up the group of optical fibers are located at the end of the ferrule.

Lastly, most fiber optic connectors include a connector body. The connector body may use a male-female configuration to facilitate alignment and coupling of the fibers. The connector body is a component that holds both corresponding fiber optic connectors (i.e., ferrule, ferrule body, and optical cable) in alignment during optical coupling. These connector bodies may be configured to hold a single type of ferrule or various different ferrules depending on the application.

While fiber optic connectors do indeed provide an efficient mechanism for optical coupling, issues still exist. The most common issues associated with fiber optic connectors are: axial run-out, poor concentricity, gap size, reflection, and power handling. Axial run-out occurs when the center lines of the corresponding fiber optic cables are oriented at an angle with respect to each other during coupling, leading to a loss of light transmitted during coupling. Poor concentricity occurs when the centers of the corresponding optical cables are not in direct alignment, leading to loss of light transmitted during coupling. Gap size refers to the distance between two corresponding ferrules during optical coupling. Increasing the distance between corresponding ferrules leads to increased loss of light transmitted during coupling. Reflection refers to light reflected at the gap between corresponding ferrules due to the difference in refractive index between the optical fiber and the air, leading to a loss of light transmitted during coupling. Power handling refers to the power of optical signals that can be handled by the connector without running an unacceptable risk of damage.

Various optical connectors have been designed to deal with these issues; however no one design has effectively solved all of these problems. It is within this context that embodiments of the present invention arise.

### BRIEF DESCRIPTION OF THE FIGURES

FIG. 1A is a cross-sectional schematic diagram illustrating a ferrule according to an embodiment of the present invention.

FIG. 1B is a front-view schematic diagram illustrating a ferrule according to an embodiment of the present invention.

FIG. 1C is a cross-sectional schematic diagram illustrating mechanical alignment and optical coupling of ferrules according to an embodiment of the present invention.

FIG. 1D is an end view schematic diagram of the mechanical alignment and optical coupling of ferrules of FIG. 1C

FIG. 1E is a schematic diagram illustrating an optical coupling configuration according to an embodiment of the present invention.

FIG. 1F is a schematic diagram illustrating an alternative optical coupling configuration according to an embodiment of the present invention.

FIG. 2A is a cross-sectional schematic diagram illustrating a fiber optic connector according to an embodiment of the present invention.

FIG. 2B is a front-view schematic diagram illustrating a fiber optic connector according to an embodiment of the present invention.

FIG. 2C is a cross-sectional schematic diagram illustrating a ferrule for a fiber optic connector having an end cap according to an alternative embodiment of the present invention.

FIG. 2D is a cross-sectional schematic diagram illustrating a ferrule for a fiber optic connector having an alternative end cap according to another alternative embodiment of the present invention.

FIG. 3A is a cross-sectional schematic diagram illustrating a connector body according to an embodiment of the present invention.

FIG. 3B is a cross-sectional schematic diagram illustrating an alternative connector body according to an embodiment of the present invention.

### DESCRIPTION OF THE SPECIFIC EMBODIMENTS

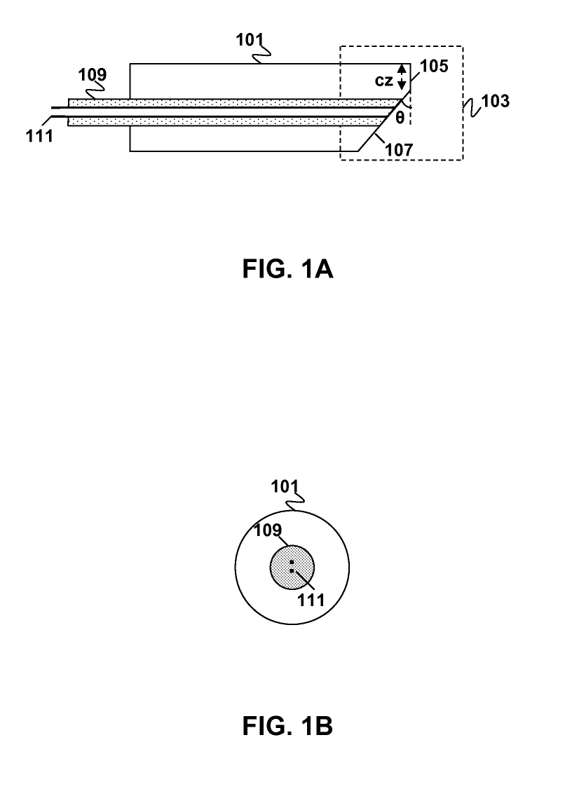

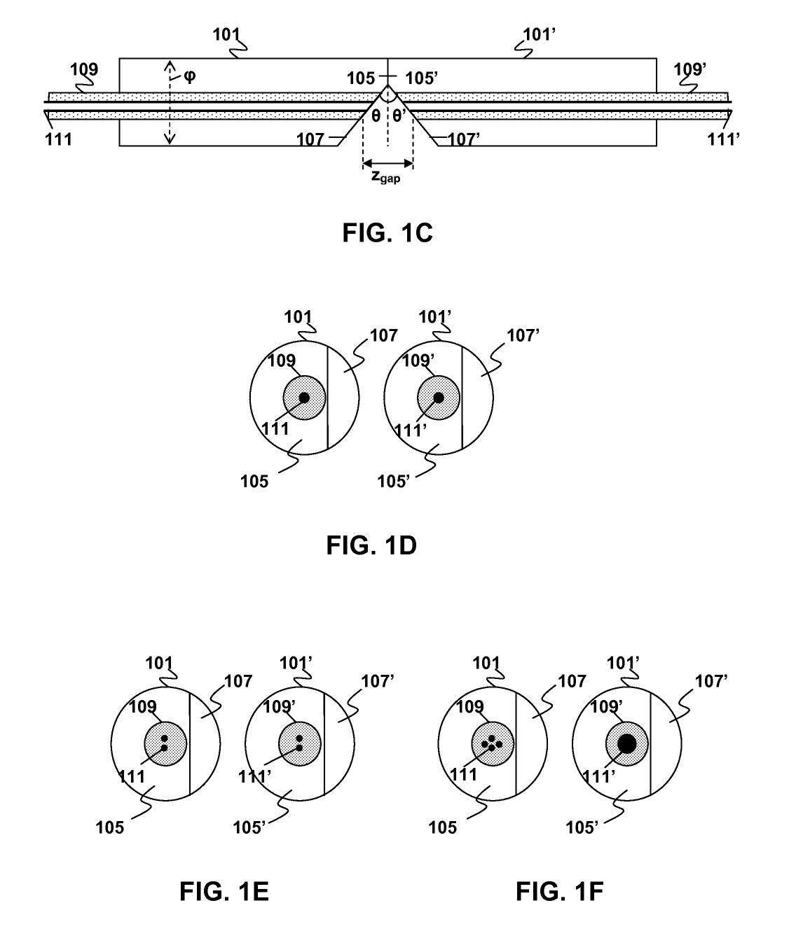

FIG. 1A and FIG. 1B respectively illustrate a side view and a top view of a ferrule 101 according to an embodiment of the present invention. The ferrule 101 includes a hollow configured to receive an optical fiber 109 having a core 111. While only a single optical fiber 109 is depicted in FIG. 1A includes with only a single core 111, it is important to note that embodiments of the invention may be used with any number of optical fibers having any number of cores, depending on the application. The ferrule 101 may be hollowed through its center in order to allow the fiber optic cable 109 to be situated such that an end of each optical fiber 109 is located at an endface 103 of the ferrule 101. The ferrule 101 is designed to facilitate efficient optical coupling of light between corresponding optical fibers by providing an alignment mechanism for corresponding optical fibers. By way of example, and not by way of limitation, the ferrule may be made of a precision ceramic material including zirconia, sapphire, or some other crystalline ceramic. Alternatively, the ferrule may be made of beryllium-copper, stainless steel, silicon carbide, or diamond.

The endface 103 of the ferrule 101 may be partitioned into two sections, a first section 105 and a second section 107. The first section 105 is perpendicular to a longitudinal axis of the ferrule 101. The height of the first section will be denoted by cz. The second section 107 is angled with respect to the first section 105 by an angle θ. Partitioning the endface 103 of the ferrule 101 in this manner allows for more efficient coupling of light between corresponding optical fibers, which will be discussed in detail in the description that follows.

FIGS. 1C-1D schematically illustrate alignment between two corresponding ferrules of the type described above. The first sections 105, 105′ of the corresponding ferrules 101, 101′ are butt-coupled (i.e., in direct physical contact). Allowing the ferrules to come into physical contact with each other provides a more accurate mechanism for alignment of the fiber cores 111, 111′ by allowing contact between the corresponding ferrules 101, 101′ to determine distance between the end faces of the fibers 109,109′. This type of physical contact helps reduce or eliminate axial runout caused by angular misalignment between the ferrules 101, 101′. Although the perpendicular first sections 105, 105′ of the endfaces of the ferrules physically touch, the angled sections 107, 107′ do not. As a result, there is a gap between the endfaces of the fibers 109, 109′, which do not physically touch since they are received at the angled sections 107, 107′.

The angled second sections 107, 107′ of the corresponding ferrules thus set a gap distance (z_{gap}) when the ferrules 101, 101′ are butt coupled, as shown in FIG. 1C. Optical signals can be coupled between corresponding optical fibers 109, 109′ across the gap between the corresponding fiber endfaces. The gap distance z_{gap} is dependent on the height of the first section cz, the angle θ formed between the second section and the first section, and the overall height of the ferrule φ. The relationship between these variables may be expressed by the following equation:

z_{gap}=2((φ/2)−cz) tan θ.

Depending on the diameters of the fibers 109, 109′, a gap distance z_{gap} of less than 100 microns can results in negligible coupling losses during transmission of light. By way of example, and not by way of limitation, for a diameter q of 3.18 millimeters the height of the first section cz may fall within the range of 0.5 mm-0.75 mm and the angle θ may fall within the range of 0.25°-3°. Examples of optical fiber and core diameters include, but are not limited to a 160 μm fiber with a 150 μm core diameter, a 450 μm fiber with a 400 μm core diameter and a 600 μm diameter fiber. It is envisaged that the solution presented herein may work with all kinds of optical fibers ranging from single-mode fiber having a core with a 5 μm diameter and a cladding with an outer diameter of 125 μm up to multimode fiber with a 1000 μm core diameter.

Creating angled sections 107, 107′ at the endfaces of each ferrule 101, 101′ helps eliminate transmission and insertion losses caused by reflection. When light is transmitted from one ferrule to another, some percentage of the light is reflected back to the transmitting ferrule. When the reflected light is coupled back to the transmitting optical fiber(s) 111, optical signals may become misdirected leading to inefficient optical coupling. The angled sections 107, 107′ can prevent reflected light from being re-coupled back into the transmitting fiber. Because of the angle of the angled sections 107, 107′, reflected light does not tend to couple into the optical fiber cores, but instead tends to couple into the cladding, where its detrimental effect is greatly diminished.

Although the angled sections 107, 107′ prevent losses due to reflection, they present the potential to introduce new losses due to the gap formed between corresponding optical fibers. However, by limiting the gap to less than about 100 microns, such losses become small enough that other loss mechanisms (e.g. Fresnel losses) dominate the coupling loss. Thus, the invented apparatus can reduce losses caused by reflection without introducing unacceptable losses caused by the air gap between corresponding optical fibers. The maximum gap size may depend on the diameter of the cores 111, 111′ of the fibers 109,109′. In some cases, if there is a step-up in core diameter between the two fibers, the amount of step-up may also affect the maximum gap distance.

It is noted that the angle on the face of the fiber is not nearly as aggressive as a Brewster angle. It is therefore reasonable to expect some Fresnel losses (e.g., about 4% per surface). The slight angle reduces the likelihood that back reflection causes feedback. The controlled gap reduces coupling losses. A step up in fiber size can also reduce losses—based on the Numerical Aperture of the fiber (NA). For example, a beam that exits a small diameter first fiber is expanding and, if the expanding beam is still small enough, more of the beam will launch into a larger diameter receiving fiber.

Although the foregoing discussion addresses coupling between single optical fibers, each having a single core, embodiments of the present invention include implementations in which there are multiple optical fibers or fibers with multiple cores. By way of example, and not by way of limitation, FIGS. 1D and 1E depicted two possible alternative configurations, among many others, illustrating how multiple optical fibers (or multiple fiber cores) may be optically coupled according to an embodiment of the invention. In FIGS. 1E and 1F, each ferrule 101, 101′ receives two or more optical fibers 109, 109′ each of which includes a core 111, 111′. FIG. 1E illustrates optical coupling in a one-to-one configuration, where the core 111 of the optical fiber 109 received in a first ferrule 101 is aligned with the core 111′ of corresponding optical fiber 109′ received in a second ferrule 101′.

However, optical coupling is not limited to one-to-one configurations. FIG. 1F illustrates optical coupling in a four-to-one configuration, where each optical fiber core 111 in a ferrule 101 has a single corresponding optical fiber core 111′ in another ferrule. It is important to note that any number of coupling configurations may be implemented using the invented apparatus. By way of example, and not by way of limitation, three 100 micron diameter optical fibers may couple light into a single 400 micron diameter optical fiber.

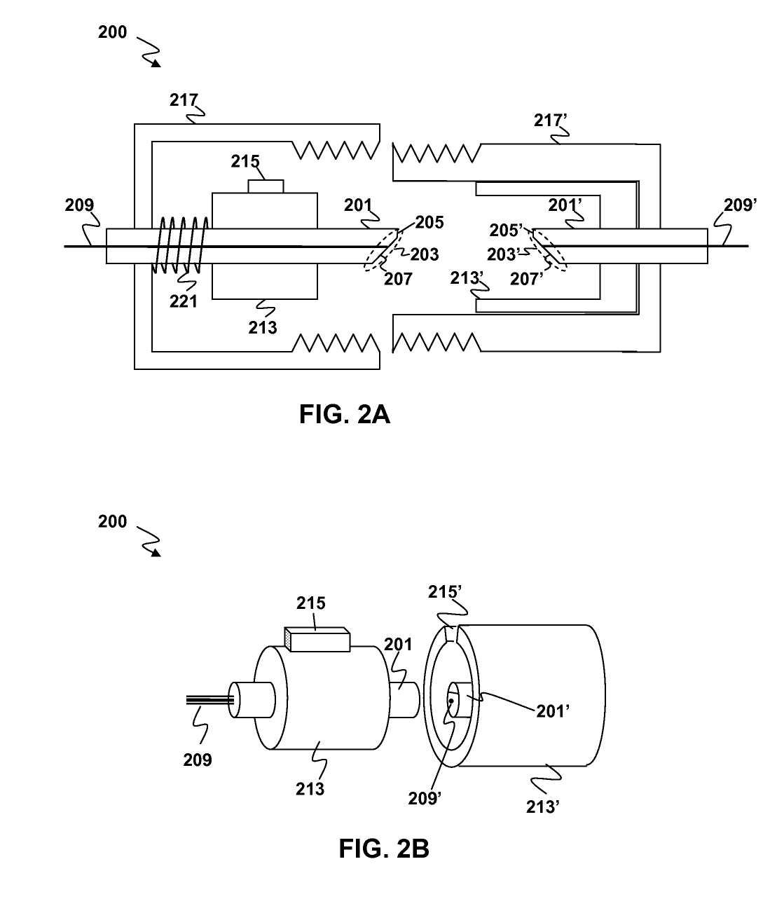

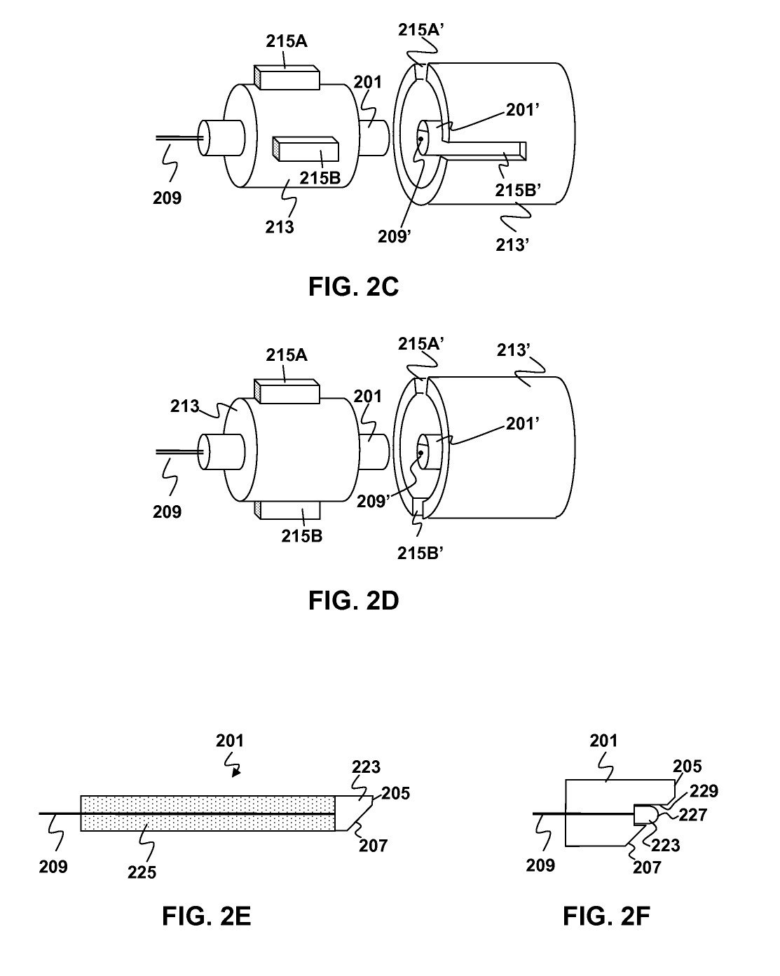

The ferrule described in FIG. 1A-1D may be further modified to ensure more accurate alignment between corresponding optical fibers and more efficient optical coupling. FIG. 2A and FIG. 2B respectively illustrate a side-view and top-view schematic diagram of a fiber optic connector 200 according to an embodiment of the present invention. This fiber optic connector 200 includes a first ferrule 201, which may be configured as described above with respect to FIG. 1A-FIG. 1D with an endface 203 with a perpendicular first section 205 and an angled second section 207 and a second similarly (or even identically) configured ferrule 201′, that includes an endface 203′ with a perpendicular first section 205′ and an angled second section 207′. When the connector 200 is assembled, the first ferrule 201 butt couples to the second ferrule 201′ such that the perpendicular second portions 205, 205′ of endfaces 203, 203′ are physically touching. The angle of the angled portions 207, 207′ sets the distance between portions of the endfaces 203, 203′ corresponding to endfaces of optical fibers 209′, 209′ received in the ferrules 201, 201′, as described above.

The connector 200 may include various optional components to facilitate efficient optical coupling. These optional components may include a male ferrule body 213 with a female ferrule body 213′, a nut 217, a spring 221, and a lens 223, e.g., as illustrated in FIG. 2F and described below. The male and female ferrule bodies 213, 213′ hold corresponding first and second ferrules 201, 201′. By way of example, and not by way of limitation, the ferrule bodies 213, 213′ may be made of any suitable material, such as metal or plastic. The ferrule 201 extends beyond the male ferrule body 213, to facilitate optical coupling. The ferrules 201, 201′ surround corresponding optical fibers 209, 209′ as described above. Rotation may cause the cores of the corresponding optical fibers to misalign, leading to transmission losses. The male ferrule body 213 may include one or more keys that mate to corresponding keyways, e.g., slots, in the female ferrule 213 body to prevent rotation of the ferrule 201 and thereby reduce the likelihood of rotational misalignment.

By way of example, and not by way of limitation, the male ferrule body 213 may include one or more keys 215 configured to act as a second alignment mechanism during optical coupling. Each key 215 may be sized and shaped to fit into a corresponding slot 215′ in the female ferrule body 213′. When the male ferrule body 213 is connected to the female ferrule body 213′ the key 215 fits into the slot 215′ and locks the ferrule body 213 and ferrule 201 in place, preventing the ferrules 201, 201′ from rotating relative to each other about their respective longitudinal axes. It is noted that embodiments of the present invention include implementations in which the locations of the key 215 and slot 215′ are reversed. In other words, the male ferrule body may include a slot and the female ferrule body may include a key.

In addition to the male ferrule body 213, the fiber optic connector 200 may also have a nut 217. The nut 217 has threads that mate to corresponding threads on a female connector body 217′. The fiber optic connector 200 may additionally include a spring 221. The spring 221 coils around the ferrule 201 and is situated between the male ferrule body 213 and the nut 217. The spring 221 is used to control the force applied by the ferrule 201 to the ferrule 201′ as they are mechanically aligned during optical coupling. Because ferrules are typically polished at the endface, any abrasions caused during alignment may greatly disturb the efficiency of the optical coupling between the optical fibers in those ferrules. Thus, the spring provides a mechanism for controlling the force with which ferrules mechanically align so that the polish qualities of the ferrules are unaffected during optical coupling.

It is noted that embodiments of the present invention include alternatives to the use of a nut for connection between the male and female connector bodies. For example, the male and female connector bodies may use a bayonet type twist-lock to compress the spring 221 instead of a threaded connection.

It is noted that the male ferrule body 213 may have multiple keys 215 that mate to multiple corresponding slots on the female ferrule body 213′. The keys and slots may be configured so that different combinations of keys may be used for coupling specific fiber cables designated for particular purposes. Alternatively, other effective indexing and keying strategies may be employed. For example, one could employ a 2-key solution that uses a master key and an index key. This would enable one design to have several user-configurable indexes. Spline-plates might also be used to allow for user-configurable keys.

As is generally understood to those skilled in the mechanical arts a “spline” generally refers to ridges or teeth on a generally cylindrical shaft (such as a drive shaft) that mesh with grooves on a mating piece and transfer torque to the mating piece and maintain angular correspondence between the shaft and the mating piece. As used herein the term “spline plate” generally refers to a spline-type joint that uses a compact plate-like member having teeth or ridges that mesh with corresponding grooves on a mating piece for transfer of torque and maintaining angular correspondence between the plate-like member and the mating piece. The main difference between a spline and a spline-plate is a relatively short length of the piece with the teeth or ridges in the axial compared to the radial direction.

By way of example, and not by way of limitation, a coupler for a fiber cable 209 carrying a pump beam may have a uniquely configured key pattern with two diametrically opposed keys 215A, 215B that will only mate to a female ferrule body 213′ having correspondingly configured slot slots 215A′, 215B′, as shown in FIG. 2C. As shown in FIG. 2D, a fiber cable 209′ carrying a mid-stage beam may have a connector with a different key pattern, e.g., one in which keys 215A, 215B are arranged at 90 degrees with respect to the ferrule body 213. The keys 215A, 215B mate to matching slots 215A′, 215B′ on the female ferrule body 213′. In this example, the male ferrule body 213 for the pump beam shown in FIG. 2C will not mate to the slot pattern for the female connector for the mid-stage beam shown in FIG. 2D. The unique key and slot patterns can thus be configured to prevent the pump beam from being coupled to a mid-stage or vice versa.

In some embodiments it may be useful to coat an end face of the fiber or fibers that make up the cable 209 with an anti-reflective (AR) coating. This can be difficult to implement, e.g. if the ferrule 201, 201′ is made of metal. If the AR coating is applied to the end face of the metal ferrule and to the end face of the fiber, the AR coating tends to flake off from the metal. To overcome this problem the fiber optic connector 200 may use a ferrule 201, 201′ having an end cap 223 attached to an end face of a cylindrical section 225, e.g., as shown in FIG. 2E. By way of example, and not by way of limitation, the cylindrical section 225 can be made of a metal, such as beryllium-copper or stainless steel or a ceramic material, such as zirconia, or some other suitable material, such as silicon carbide or diamond. The end cap 223 can be made of a suitable optically transparent material such as silica, e.g., in the form of glass or quartz. The end face of the end cap 223 can include a perpendicular first section 205 and an angled second section 207, e.g., as described above. The end cap may be attached to the fiber(s) in the cable 209, e.g., by diffusion bonding or laser welding.

The advantages of the end cap 223 are as follows. Typical damage that occurs during optical coupling includes surface pitting or edge chipping. When the power density of an optical signal is moderate in comparison to the size of the optical fiber (e.g., 80-100 W through a 400 micron fiber), damage to the optical fiber may be limited below 10%. These damage regions are roughly 1-10 microns in size. With this amount of damage, the optical fiber may still function. However, as the power density of optical signals increases or as the optical fibers become smaller in size, the magnitude of damage increases and the optical fiber's ability to function effectively decreases. By introducing an end cap 223, the effective area of the fiber endface is increased, resulting in a reduction of fluence and a decrease in the amount of damage suffered by the optical fiber(s) in the cable 209.

There are a number of variations on the end cap configuration. For example, as illustrated in FIG. 2F, the end cap 223 may have a rounded end face 227 that acts as a lens. Alternatively, the end cap 223 may take the form of any number of different shapes. By way of example and not by way of limitation, the ferrule 201 may include the perpendicular end face section 205 and angled end face section 207. The end cap 223 may be received in a recess 229 in the end face of the ferrule 201.

By way of example, and not by way of limitation, the end cap 223 may be composed of fused silica. The end cap 223 may be attached to the ferrule through diffusion bonding or laser welding. Additionally, the end cap may be coated with an anti-reflective coating to reduce the occurrence of reflection during optical coupling.

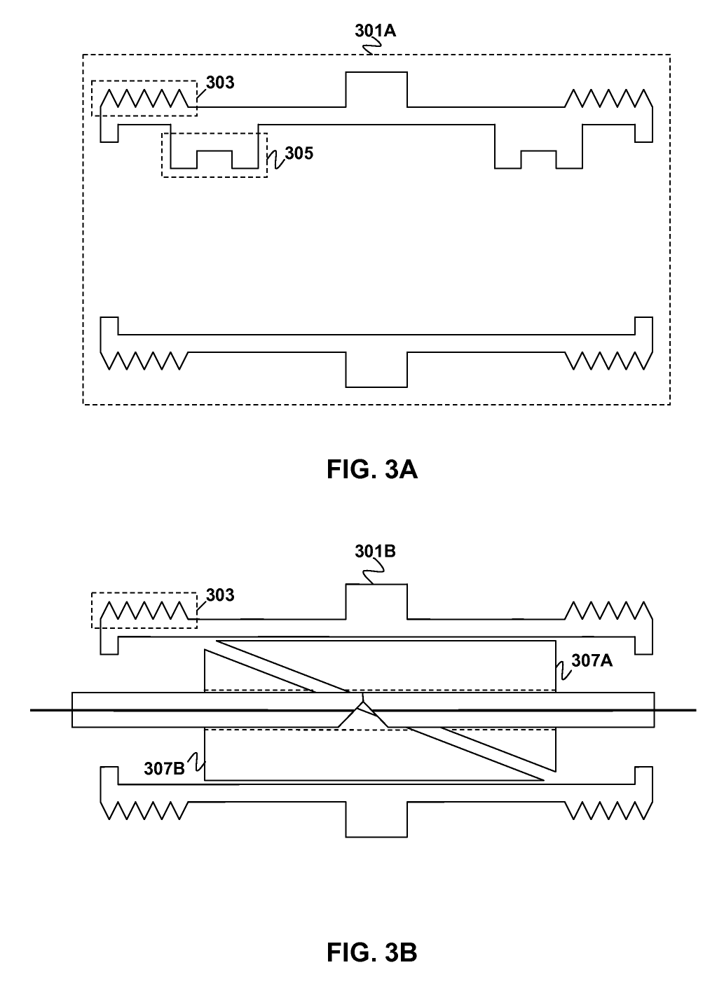

According to an alternative embodiment of the invention, fiber optic connectors, such as those described in FIG. 2A to FIG. 2F may be mechanically aligned and optically coupled to a corresponding fiber optic connector through a connector body, as mentioned above. FIG. 3A and FIG. 3B illustrate examples of connector bodies that may be used conjunction with fiber optic connectors of the types described above. A connector body 301A, 301B is a component that holds corresponding fiber optic connectors (i.e., ferrule, ferrule body, and optical cable) in alignment during optical coupling. The connector body 301A, 301B may have threads 303 that are compatible with the nut of a corresponding fiber optic connector. As shown in FIG. 3A, the connector body 301A may also have a corresponding key 305 that mates to a corresponding slot on the ferrule body of a corresponding fiber optic connector. The key/slot configuration can lock the ferrule body and ferrule into place during optical to prevent rotational misalignment from occurring. It is noted that the connector body 301A may have more than one key 305 to allow for alignment of different combinations of fiber optic connectors. Alternatively, the connector body may include one or more slots that mate to matching keys on the ferrule body.

Alignment using the connector body may be further aided using a split-sleeve. FIG. 3B illustrates such a connector body with an additional split-sleeve according to an embodiment of the present invention. A diagonal-split sleeve made of diagonally cut sleeve portions 307A, 307B may be used to hold corresponding ferrules in place, such that they become centrally aligned when they are properly inserted into their respective sleeves. As used herein, two ferrules are said to be “centrally aligned” if an axis of one ferrule received in the sleeve is aligned with a corresponding axis of another ferrule received in the sleeve. By way of example, and not by way of limitation, two corresponding axially symmetric ferrules may have holes in their respective endfaces where hollows intersect the endfaces. The ferrules may be regarded as centrally aligned if the axes of the ferrules are aligned and the hole in the endface of one corresponding ferrule is centered with respect to the hole in the endface of the other corresponding ferrule. The split-sleeves reduce the likelihood of mechanical misalignment.

While the above is a complete description of the preferred embodiment of the present invention, it is possible to use various alternatives, modifications and equivalents. Therefore, the scope of the present invention should be determined with reference to the appended claims, along with their full scope of equivalents. Any feature, whether preferred or not, may be combined with any other feature, whether preferred or not. In the claims that follow, the indefinite article “A”, or “An” refers to a quantity of one or more of the item following the article, except where expressly stated otherwise. The appended claims are not to be interpreted as including means-plus-function limitations, unless such a limitation is explicitly recited in a given claim using the phrase “means for”.

What is claimed is:

1. An optical fiber connector apparatus, comprising:
a ferrule having a hollow through its center, the hollow being sized and shaped to receive an optical fiber such that an end of each of the optical fiber is located at an endface of the ferrule, wherein an endface of the ferrule is partitioned into a first section and a second section, the first section being perpendicular to an axis of the ferrule and the second section being angled with respect to the first section.

2. The apparatus of claim 1, wherein the ferrule is composed of zirconia.

3. The apparatus of claim 1, wherein the ferrule is composed of sapphire, beryllium-copper, stainless steel, silicon carbide, or diamond.

4. The apparatus of claim 1, wherein the ferrule is composed of crystalline ceramic.

5. The apparatus of claim 1, wherein the angle formed between the second section of the ferrule and the first section of the ferrule falls between the range of 0.25 degrees and 3 degrees.

6. The apparatus of claim 1, wherein the ferrule includes a transparent end cap.

7. The apparatus of claim 6, wherein the end cap includes the endface.

8. The apparatus of claim 6, wherein the end cap includes a curved refractive surface that acts as a lens.

9. The apparatus of claim 1, further comprising a ferrule body configured to receive the ferrule.

10. The apparatus of claim 9, further comprising a connector body configured to receive the ferrule body.

11. The apparatus of claim 10, wherein the connector body includes a split sleeve, the split sleeve being configured to centrally align the ferrule and an additional ferrule received in the split sleeve.

12. The apparatus of claim 10, further comprising a spring configured to urge the ferrule body and ferrule towards an additional ferrule disposed in the connector body.

13. The apparatus of claim 10 wherein the ferrule is received in the connector body.

14. The apparatus of claim 10 wherein the connector body is configured to receive the ferrule body and an additional ferrule body.

15. The apparatus of claim 14, wherein the ferrule body and additional ferrule body are received in the connector body, wherein the additional ferrule body has an additional ferrule received therein, wherein the additional ferrule includes a hollow through its center, the hollow being sized and shaped to receive a an additional optical fiber such that an end of the additional optical fiber is located at an endface of the ferrule, wherein an endface of the ferrule is partitioned into a first section and a second section, the first section being perpendicular to an axis of the ferrule and the second section being angled with respect to the first section.

16. The apparatus of claim 15, wherein the first and second sections of the ferrule and the additional ferrule are configured such that, when the second sections are in contact with each other, locations at the endfaces of the ferrule and additional ferrule corresponding to locations of end faces of the optical fiber the additional optical fiber are separated by a distance of 100 microns or less.

17. The apparatus of claim 15 wherein the connector body, ferrule body, ferrule, additional ferrule body, and additional ferrule are configured such that the first section of the endface of the ferrule contacts the first section of the endface of the additional ferrule.

18. The apparatus of claim 17, further comprising an optical fiber received in the hollow in the ferrule, wherein an end face of the optical fiber received in the hollow in the ferrule is located at the second section of the endface of the ferrule.

19. The apparatus of claim 18, wherein the optical fiber received in the hollow in the ferrule includes a core and a cladding, wherein the core has a diameter between 5 microns and 1000 microns.

20. The apparatus of claim 18, further comprising an additional optical fiber received in the hollow in the additional ferrule, wherein an end face the additional optical fiber received in the hollow in the additional ferrule is located at the second section of the endface of the additional ferrule.

21. The apparatus of claim 17, further comprising an optical fiber received in the hollow in the ferrule, wherein the ferrule includes a section containing the hollow and an end cap attached to the section containing the hollow, wherein the end cap includes the endface of the ferrule, wherein an end face of the optical fiber received in the hollow in the ferrule is located at the end cap of the ferrule.

22. The apparatus of claim 21, wherein the first and second sections of the ferrule and the additional ferrule are configured such that, when the second sections are in contact with each other, locations at the endfaces of the ferrule and additional ferrule corresponding to locations of the end face of the optical fiber and the additional optical fiber are separated by a distance of 100 microns or less.

23. The apparatus of claim 21, further comprising an additional optical fiber received in the hollow in the additional ferrule, wherein the additional ferrule includes a section containing the hollow and a transparent end cap attached to the section containing the hollow, wherein the end cap includes the endface of the additional ferrule, wherein an end face of the additional optical fiber received in the hollow in the additional ferrule is received by the end cap of the additional ferrule.

24. The apparatus of claim 23, wherein the end cap includes a rounded surface configured to act as a lens.

25. The apparatus of claim 23, wherein the endcap is coated with an anti-reflective (AR) coating.

26. The apparatus of claim 1, further comprising a ferrule body configured to receive the ferrule, the ferrule body including one or more keys configured to fit into one or more corresponding keyways in a mating connector element configured to receive the ferrule body.

27. The apparatus of claim 26, further comprising the mating connector element having the one or more corresponding keyways, wherein the one or more keys and one or the more corresponding keyways are configured to prevent the ferrule from rotating about a central axis relative to the mating connector element into a predetermined rotational alignment.

28. The apparatus of claim 26, wherein the one or more keys and one or corresponding keyways are configured in a unique pattern associated with a particular type of optical signal carried by an optical fiber received in the ferrule.
